(19) United States
(12) Patent Application Publication
(10) Pub. No.: US 2012/0013922 A1
(43) Pub. Date: Jan. 19, 2012

(54) Print Data Format Modification Mechanism

(76) Inventors: Michael G. Lotz, Longmont, CO (US); Thomas N. Bilan, Longmont, CO (US); Donald A. Johnson, Longmont, CO (US)

(21) Appl. No.: 12/838,618

(22) Filed: Jul. 19, 2010

(51) Int. Cl. G06F 15/00

(52) U.S. Cl. 358/1.9

(57) ABSTRACT

A method is disclosed. The method includes establishing a post processing data format to enable proper post-processing of print jobs and modifying a print job received during print processing according to the post processing data format.

### FIELD OF THE INVENTION

The invention relates to the field of printing systems. Particularly, the invention relates to modifying print job data to a proper post-processing format.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer.

Once a connection is established between a workstation and the printer, printing software is implemented at a print server to manage a print job from order entry and management through the complete printing process. Subsequently, post-processing may be performed after a job has been printed. For instance, printer users may wish to print and feed documents to an inserter, which inserts one or more documents into an envelope.

However, the configuration for the printer and inserter may vary. For instance, data may sometimes be inserted on equipment that needs the data printed in a 2-up (e.g., two print pages per page of paper) format with the start page on the left, while another inserter may require the same data have a start page on the right. Further, an operations department may decide to place the print data output on rolls, instead of folded. Each of the above variations effect the format for which a job is to be printed when considering insertion. For example, when placed on rolls the print data output must be reversed and reoriented, when compared to output that is folded, to enable the inserter to receive the data in the proper order.

Moreover, data on addressed documents may need to be printed in certain orientations, depending on an address location on a document, so that the inserter equipment may properly align the address with the address window of an envelope. Each of the above options may result in difficulties in getting data printed and inserted correctly. Currently, the only reliable method for solving this problem is through trial and error by creating a document Form Definition (formdef) and testing it. Nonetheless, it is difficult to achieve the correct settings because of the variability in the formdef specifications when different orientations, duplex and paper sizes are used, resulting in much time being wasted guessing at the correct setup.

Accordingly, a mechanism to efficiently manipulate print data format for proper insertion is desired.

### SUMMARY

In one embodiment a method is disclosed. The method includes establishing a post processing data format to enable proper post-processing of print jobs and modifying a print job received during print processing according to the post processing data format

In another embodiment, a printing system is disclosed. The printing system includes a host system having print software to receive and manage print jobs, a printer to provide a printed output by printing the print jobs on a medium and a post processing component to perform post processing on the printed output. The print software establishes a post processing data format to enable the printer to provide the printed output in a format that enables accurate post-processing at the post processing component and modifies a print job received during print processing according to the post processing data format.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 is a flow diagram illustrating one embodiment of providing a data format;

FIG. 3 is a flow diagram illustrating one embodiment of manipulating print data; and

FIG. 4 is a flow diagram illustrating one embodiment of normalizing print data.

### DETAILED DESCRIPTION

A mechanism for modifying print data format for post processing is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

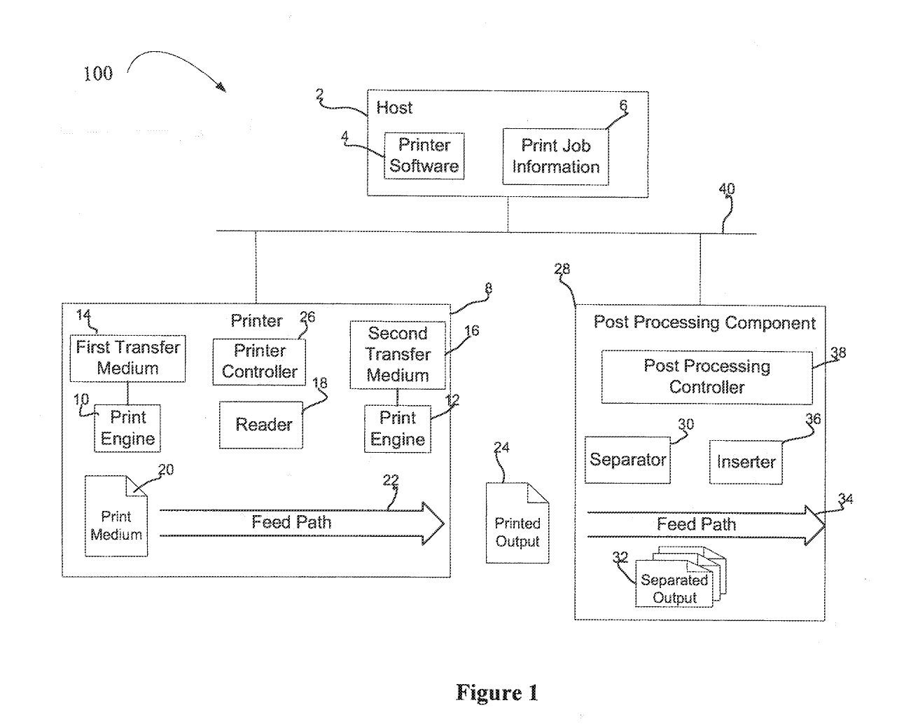

FIG. 1 illustrates one embodiment of a printing system 100. Printing system 100 includes a host system 2 having print software 4 to manage print jobs and to maintain print job information 6 on the status of print jobs managed by the print software. In one embodiment, print software 4 may be implemented using either InfoPrint Manager (IPM) or InfoPrint ProcessDirector (IPPD), although other types of printing software may be used instead.

The term print job as used herein refers a print job or any component thereof, including a page of print content, a page including multiple print items or elements, such as checks, pages, an element on a page, etc. The print job may further include one or more pages, where each page has one or more elements, e.g., checks. A page may comprise a unit of print output, where the page may be outputted on a single piece of paper or multiple pages may be outputted on a roll, ribbon or web of paper. Pages may be outputted on a web of paper in different formats, such as 2-up duplex. Each of the pages on a web or roll of paper may include multiple elements. The web of paper may include print jobs, where each print job is one or more pages, and where each page includes one or more elements. In this way, elements and pages may be grouped in print jobs.

The host system 2 may include a processor (not shown) and memory (not shown) in which the print software 4 and print job information 6 is stored for access by the processor. According to one embodiment, host system 2 implements the (Advanced Function Presentation) AFP™ presentation system developed by International Business Machines Corporation to represent documents in a data format that is independent of the methods that are utilized to capture or create those documents.

According to the AFP system, documents may include combinations of text, image, graphics, and/or barcode objects in device and resolution independent formats. Documents may also include and/or reference fonts, overlays, and other resource objects, which are required at presentation time to present the data properly. In other embodiments, additional/alternative presentation architectures may be implemented at host system 2.

However in an AFP embodiment, the host system 2 receives a Mixed Object Document Content Architecture (MO:DCA) data stream. In such an embodiment, the AFP MO:DCA data streams are object-oriented streams including, among other things, data objects, page objects, and resource objects. In a further embodiment, AFP MO:DCA data streams include a Resource Environment Group (REG) that is specified at the beginning of the AFP document, before the first page. When the AFP MO:DCA data streams are processed by print server 108, the REG structure is encountered first and causes the host system 2 to download any of the identified resources that are not already present in a printer 8.

The host system 2 communicates print jobs to the printer 8, where each print job may have one or more pages or elements, and where each page may have one or more elements. The printer 8 includes a first 10 and second 12 print engines to print output using first 14 and second 16 types of transfer media and a reader 18 capable of reading content printed using the first transfer medium 14.

A transfer media 14 and 16 includes the material or energy that is used to cause the formation of content on the print medium 20, such as toner, liquid ink, solid ink, dye, wax, heat (which when applied to thermal paper produces the print content), etc. A print medium 20, such as a piece of paper or other material or textile, is directed through a feed path 22 by mechanical components of the printer 8, such as rollers, guides, etc. In the feed path 22, the first print engine 10 prints first content of the one or more pages of one or more print jobs on the print medium 20 using the first transfer medium 14. The first content that is printed may comprise an element, a page, a page of elements, etc.

The reader 18 reads the printed first print content to determine the quality of the output. The reader 18 may read each element on one or more pages to determine the quality of each outputted element. The reader 18 forwards the print medium 20 to the second print engine 12 to print second content using the second transfer medium 16 to produce printed output 24 including one or more print jobs of one or more pages having one or more elements printed using both types 14 and 16 of transfer media.

The printer 8 may include a printer controller 26 to control printing operations and interface with the printer software 4 to execute the commands from the printer software 4 and provide feedback thereto. The print engines 10 and 12 may include the hardware and/or software to control the printing of content using the first 14 and second 16 types of transfer media, respectively.

The printed output 24 is forwarded to a post processing component 28 which performs various post processing operations on the printed output 24. In one embodiment, the print processing component 28 includes a separator 30 to physically separate the printed output 24 into multiple pieces comprising separated output 32, each piece including one or more print jobs. Each instance of separated output 32 of the printed output 24 may then be forwarded along a feed path 34 to an inserter 36 to insert the separated output 32 content into an envelope and/or to perform additional post processing on the separated output 32.

The additional post processing performed on the separated output 32 pieces may include stapling, collating, printing, labeling, etc. The post processing component 28 then outputs the separated output 32 in a final form, which may comprise envelopes including the separated output 32 pieces. The post processing component 28 may include a post processing controller 38 to control post processing operations and interface with the printer controller 26 and printer software 4 to execute the commands from the printer software 4 and provide feedback thereto.

An interface 40 provides intercommunication among the host 2, the printer 8, and the post processing component 20. The interface 40 may include a network, such as a Local Area Network (LAN), a Wide Area Network (WAN), a wireless network, etc. Alternatively, the interface 40 may include a bus interface, parallel interface, serial interface, or other direct line connection. In the embodiment of described herein, the host 2, printer 8, and post processing component 20 are shown as included in separate boxes. In an alternative implementation, the printer 8 and post processing component 20 may be included in a single machine connected via one connection to the host 2. Alternatively, all three devices 2, 8, and 20 may be included in one machine.

As described above, print data received at printer software 4 may be formatted to print according to a predefined format. However, the format may not correspond to a format necessary for proper placement of print output at inserter 36. According to one embodiment, printer software 4 establishes a data format that enables printed documents to be properly inserted at inserter 36. In such an embodiment, the data format is established using a description provided to printer software 4.

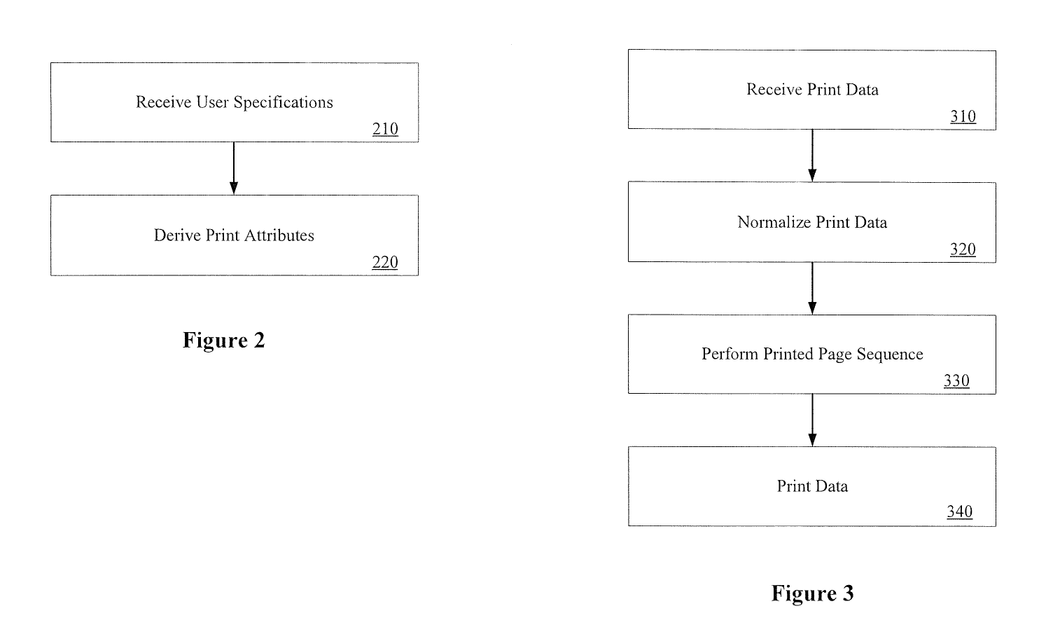

FIG. 2 is a flow diagram illustrating one embodiment of establishing a print data format. At processing block 210, printer software 4 receives user specifications. In one embodiment, the user specifications include input data format, data normalization and finishing equipment setup attributes. Input data format attributes include Input Page Sequence, which describes the page sequence of the input data (e.g., input ordered first to last (or A-Z) or last to first (or Z-A)) and Input Page Orientation, which describes the print layout of the input data (e.g., input is north (or 0 degrees), east (or 90 degrees), south (or 180 degrees), or west (or 270 degrees)).

Data normalization attributes received as input by printer software 4 include the following attributes: Medium Overlay Handling that removes medium overlays or converts medium overlays to page overlays; and Simplex Conversion Rule for fronts only or fronts and backs. Finishing equipment setup attributes include a first page of insert sequence that provides a sequence description from the logical top of the paper as it goes into inserter 36. Thus, the inserter 36 stacking orientation is described relative to the right side (east) or the left side (west). Possible values include left (west-east) or right (east-west).

Finishing equipment setup attributes also include Inserter Page Sequence that provides that if the pages are to be presented to inserter 36 in A-Z order then first to last is the correct specification, and if the order into the inserter is Z-A then last to first should be specified. Further, when the pages are reversed in the print data stream, necessary blank pages are to be added so that the first sheet provided to inserter 36 is not blank. Possible values for this attribute include first to last or last to first.

An Inserter Page Orientation attribute is also included, which describes orientation from the logical top of the paper as it goes into inserter 36. The inserter 36 page orientation is described relative to north (0 degrees) being up, east (90 degrees) being the right hand side, south (180 degrees) being down and west (270 degrees) being left. Possible values include north, east, south, or west. A Leading Paper Edge attribute describes the leading paper edge into inserter 36 as the leading print edge or the trailing print edge. Possible values include leading print edge or trailing print edge.

The Duplex attribute is provided to describe whether the finished sheet of paper has a specific duplex or simplex value. If the finished sheet is simplex, simplex is specified. If the finished sheet is printed on both sides and the back side logical top is on the same physical end of the paper as the front side, normal duplex is specified. If the finished sheet is printed on both sides, and the back side logical top is on the opposite physical end of the paper as the front side, tumble duplex is specified. A generic duplex value will select the default based on a calculated print page orientation where north and south are normal duplex and east and west are tumble duplex. Possible values include simplex, duplex, normal duplex, tumble duplex.

A n-Up attribute describes the logical top of the paper as it goes into inserter 36. If the data is two side by side sheets but it is desired to have the printer cause this with printer settings, the Default 1-up value will allow the printer to affect the output. The other settings specifically will set the value. Possible values include default 1-up, 1up, 2-up or 3-up. Print side describes the viewing of the paper as it goes into inserter 36. Print side specifies the paper side that is face up going into the printer (typically this is the front side of the paper). Possible values include front side or back side.

A Form Type attribute is described by viewing the physical paper that is fed to the printer. Paper that has a printable area that is wider than it is tall, is wide with all other cases being narrow. In the case where the paper is pin feed, the physical paper is typically 1 inch wider than the printable area. Possible values include wide or narrow. Printer Type has possible values including cut sheet or continuous forms.

Image Offsets specify the offset of the pages from the left gutter. These are used to shift the printed page images to align printed output when necessary. Possible values include numeric offsets, wherein the values may be negative. Explicit Paper Width Adjustments specifies exact dimension of the printable area when paper is non-standard. In rare cases this option specifies the medium size which is used in placing the data on the sheet.

Once the user specifications have been received, print attributes are derived, processing block 220. In one embodiment, deriving the print attributes includes calculating the printed page sequence. For instance, if the leading paper edge is equal to the trailing print edge, the printed page sequence is equal to the opposite value of inserter page sequence. If the leading paper edge is equal to leading print edge, the printed page sequence equals the value of inserter page sequence.

Once the data format description is provided, the printer controller 26 may subsequently use the description to modify actual page data and layout information received during print processing into the required format. FIG. 3 is a flow diagram illustrating one embodiment of modifying print data during print processing. At processing block 310, print data (e.g., AFP data stream) is received at printer software 4.

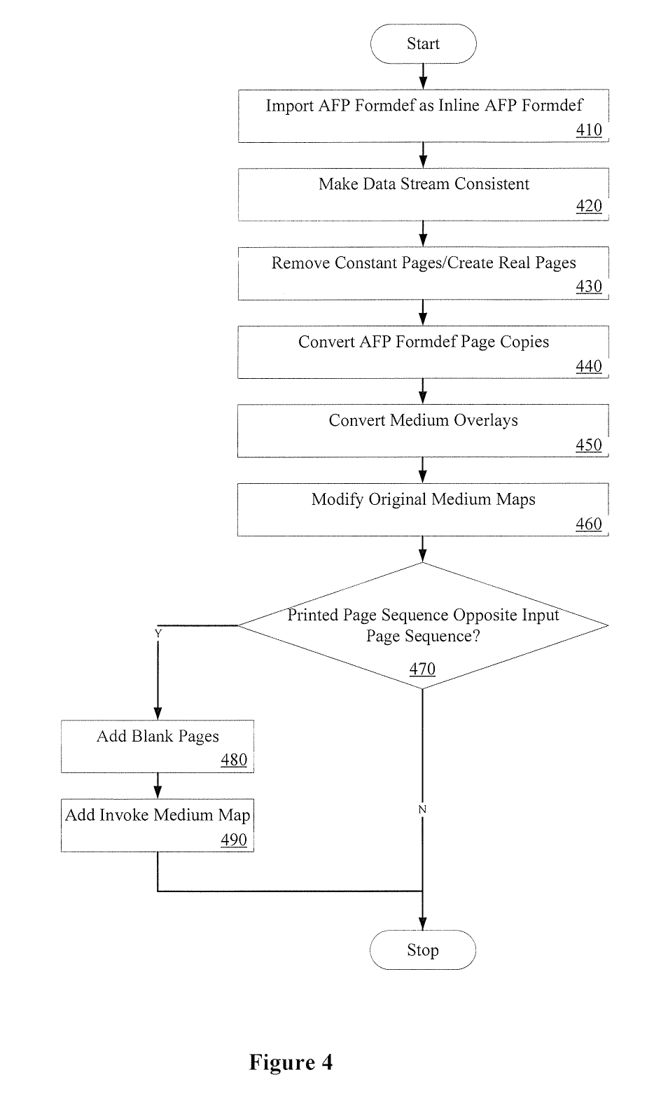

At processing block 320, the print data is normalized to enable the pages to print in the proper locations and orientations so that the data is presented to post processing component 28 in the correct format. FIG. 4 is a flow diagram illustrating one embodiment of normalizing print data. At processing block 410, the AFP Formdef is imported into the print data stream as an inline AFP Formdef. At processing block 420, the data stream is made consistent in terms of Simplex or Duplex. In one embodiment, converting simplex data into duplex data includes two possible options: Fronts Only (with blank backs) or Fronts And Backs (where the back of the page is what would have been printed on the front of the next simplex page).

At processing block 430, constant pages are removed from the AFP Formdef and real pages in the print data stream are created that represent the constant pages. At processing block 440, AFP Formdef page copies are converted into real pages in the print data stream. At processing block 450, Medium Overlays in the AFP Formdef are converted to Page overlays. However in other embodiments, the Medium Overlays may be removed.

At processing block 460, the original medium maps are modified to produce the correct printed output using the specified attributes. In one embodiment, these attributes include Input Page Sequence, Input Page Orientation, First Page of Insert Sequence, Inserter Page Orientation, Leading Paper Edge, Duplex, N-up, Print Side, Form Type, Printer Type, Image Offsets, Explicit Paper Width Adjustments and calculated attributes including Printed Page Sequence. In a further embodiment, the attributes map into AFP Formdef options to allow the pages of data to print correctly. In still a further embodiment, these values are translated to the AFP Formdef using a table lookup and mappings. However, other translation mechanisms may be implemented (e.g., mathematical algorithms).

At decision block 470, it is determined whether the calculated printed page sequence is opposite the Input Page Sequence. If not, the process has been completed. Otherwise, blank pages are added into the data stream if the printed output is to be Duplex, processing block 480. This process is performed so that all pages are accounted for in the page data. There are typically two scenarios for blank page creation: (1) Between Invoke Medium Maps there should be an even number of pages and (2) every named group should contain an even number of pages. At processing block 490, Invoke Medium Map structured fields are added at page group boundaries to allow optimization of reordering.

Referring back to FIG. 3, is a flow diagram illustrating one embodiment of manipulating print data during print, a printed page sequence is calculated after the print data is normalized, processing block 330. If the calculated printed page sequence is opposite the input page sequence, additional blank sheets are added, if necessary, at the beginning of the output print file so that the final printed data is correctly aligned as full print sheets at the end of the print file. Subsequently, the pages from the input page sequence are reordered to the printed page sequence. The Invoke Medium Maps is then correctly position so that the printed output fidelity is maintained. New medium maps are created if needed to maintain output fidelity. At processing block 340, the print data stream is printed.

Although described with implementation by printer software 4, the processes may, in other embodiments, be implemented at other components within printing system 100. For instance, printer controller 26 may be implemented to perform the processes.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method comprising:
establishing a post processing data format to enable proper post-processing of print jobs; and
modifying a print job received during print processing according to the post processing data format.

2. The method of claim 1 wherein establishing the post processing data format comprises:
receiving specifications; and
deriving print attributes from the specifications.

3. The method of claim 2 wherein the specifications comprise input data format, data normalization and equipment setup attributes.

4. The method of claim 2 wherein deriving print attributes from the specifications comprises calculating a printed page sequence.

5. The method of claim 1 wherein modifying a print job comprises:
normalizing print data within the print job; and
performing a printed page sequence.

6. The method of claim 5 further comprising printing the print job.

7. The method of claim 6 further comprising post-processing the print job.

8. The method of claim 7 wherein post-processing the print job comprises inserting pages of the print into envelopes.

9. A printing system comprising:
a host system having print software to receive and manage print jobs;
a printer to provide a printed output by printing the print jobs on a medium; and
a post processing component to perform post processing on the printed output,
wherein the print software establishes a post processing data format to enable the printer to provide the printed output in a format that enables accurate post-processing at the post processing component and modifies a print job received during print processing according to the post processing data format.

10. The printing system of claim 9 wherein establishing the post processing data format comprises receiving specifications and deriving print attributes from the specifications.

11. The printing system of claim 10 wherein the specifications comprise input data format, data normalization and equipment setup attributes.

12. The printing system of claim 10 wherein deriving print attributes from the specifications comprises calculating a printed page sequence.

13. The printing system of claim 9 wherein modifying a print job comprises normalizing print data within the print job and performing a printed page sequence.

14. The printing system of claim 10 wherein the post-processing component comprises an inserter.

15. An article of manufacture comprising a machine-readable medium including data that, when accessed by a machine, cause the machine to perform operations comprising:
establishing a post processing data format to enable proper post-processing of print jobs; and
modifying a print job received during print processing according to the post processing data format.

16. The article of manufacture of claim 15 wherein establishing the post processing data format comprises:
receiving specifications; and
deriving print attributes from the specifications.

17. The article of manufacture of claim 16 wherein the specifications comprise input data format, data normalization and equipment setup attributes.

18. The article of manufacture of claim 15 wherein modifying a print job comprises:
normalizing print data within the print job; and
performing a printed page sequence.

19. The article of manufacture of claim 18 when accessed by the machine, further cause the machine to perform operations comprising:
printing the print job; and
post-processing the print job

20. The article of manufacture of claim 19 wherein post-processing the print job comprises inserting pages of the print into envelopes.
